(19) United States
(12) Patent Application Publication
(10) Pub. No.: US 2012/0154943 A1
(43) Pub. Date: Jun. 21, 2012

(54) Apparatus and Method Used to Promote and Practice Proper Dental Hygiene

(76) Inventor: Marrio Rhodan Thomas, Memphis, TN (US)

(21) Appl. No.: 13/286,521

(22) Filed: Nov. 1, 2011

Related U.S. Application Data
(60) Provisional application No. 61/409,105, filed on Nov. 1, 2010.
(60) Provisional application No. 61/419,027, filed on Dec. 2, 2010.
(60) Provisional application No. 61/450,448, filed on Mar. 8, 2011.

(51) Int. Cl. G02B 7/182

(52) U.S. Cl. 359/882; 359/871

(57) ABSTRACT

An apparatus to practice proper dental hygiene is disclosed. The apparatus comprises (a) a base support, (b) an adjustable shaft extending upward substantially perpendicular to the base support, and (c) a console board substantially horizontal to the base support, wherein the console board comprises a plurality of designated areas. A method to practice proper dental hygiene is also disclosed.

This application claims benefit of and priority to U.S. Provisional Application No. 61/409,105, filed Nov. 1, 2010, and is entitled to that filing date for priority. The specification, figures and complete disclosure of U.S. Provisional Application No. 61/409,105 are incorporated herein by specific reference for all purposes. The application claims benefit of and priority to U.S. Provisional Application No. 61/419,027, filed Dec. 2, 2010. The specification, figures and complete disclosure of U.S. Provisional Application No. 61/419,027 are incorporated herein by specific reference for all purposes. The application claims benefit of and priority to U.S. Provisional Application No. 61/450,448, filed Mar. 8, 2011. The specification, figures and complete disclosure of U.S. Provisional Application No. 61/450,448 are incorporated herein by specific reference for all purposes.

### FIELD

The present invention relates generally to a dental apparatus used to promote dental hygiene. More specifically, the present invention relates to a dental apparatus used to encourage young children to learn and practice proper dental hygiene.

### BACKGROUND

Children, as well as some adults, do not know about nor appreciate proper dental hygiene. For example, children often do not consistently brush their teeth nor do children appreciate the importance of brushing their teeth for a particular length of time. Also, children are not knowledgeable of the dental anatomy nor are they knowledgeable of plaque and bacteria that may become present in the event of poor dental hygiene. Typically, it is the responsibility of a child's parents or other caregiver to make sure the child is brushing his or her teeth. Inconsistency in practicing proper dental hygiene will often result in dental problems such as tooth decay, plaque and gum disease. Such dental problems will require dental work which is costly, time consuming and may be uncomfortable or even painful.

Accordingly, an apparatus is needed that promotes dental hygiene and encourages children, as well as adults, to practice proper dental hygiene.

### BRIEF SUMMARY

An apparatus used to promote and practice proper dental hygiene are disclosed. The apparatus comprises a base support, an adjustable shaft extending upward substantially perpendicular to the base support and a console board substantially parallel to the base support. The console board comprises a plurality of designated areas. In one embodiment, the apparatus comprises a mirror contiguous to the console board. The mirror may extend upwards perpendicular to the console board. In one embodiment, the mirror comprises a plurality of lights. In another embodiment, the mirror comprises a handle.

In one embodiment, the console board comprises a slot. In another embodiment, the console board comprises a system. In still a further embodiment, the console board comprise a compartment. In one example embodiment, a neck is contiguous to the shaft.

A method used to promote and practice proper dental hygiene is also disclosed. The method comprises the steps of: (a) obtaining an apparatus comprising a base support, an adjustable shaft extending upward substantially perpendicular to the base support and a console board substantially parallel to the base support, wherein the console board comprises a plurality of designated areas and (b) using the apparatus to practice proper dental hygiene. In one embodiment, the apparatus of step (a) comprises a mirror contiguous to the console board, wherein the mirror extends upward perpendicular to the console board. In one embodiment, the console board comprises a system. In another embodiment, step (b) comprises setting an alarm to summon a user to the apparatus to practice dental hygiene.

### BRIEF DESCRIPTION OF THE DRAWINGS

The present disclosure will be better understood by reference to the following detailed description when considered in conjunction with the accompanying drawing wherein:

FIG. 1 is a perspective view of a dental apparatus in accordance with an exemplary embodiment of the present invention.

FIG. 2 is a top perspective view of the dental apparatus of FIG. 1.

FIG. 3 is a side perspective view of the dental apparatus of FIG. 1.

### DETAILED DESCRIPTION

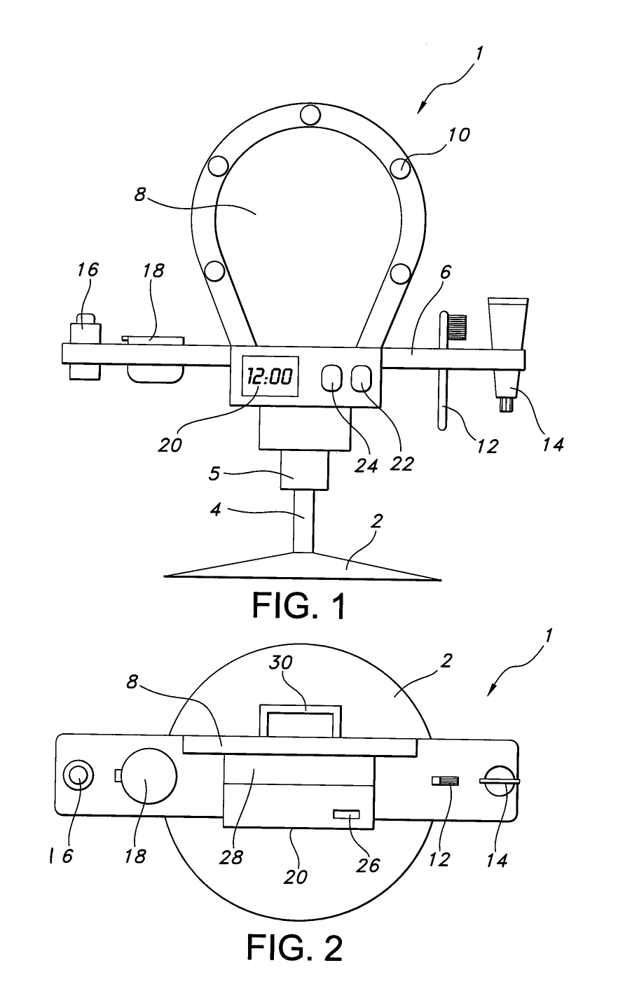

Referring to FIGS. 1 to 3, various embodiments of the present disclosure comprise a dental apparatus 1 used to promote and practice proper dental hygiene. Further, dental apparatus 1 is an interactive aide used to encourage users to practice proper dental hygiene, and to educate and equip users regarding dental anatomy and proper dental hygiene.

In one exemplary embodiment, as shown in FIGS. 1 to 3, dental apparatus 1 comprises a pedestal or base support 2, an adjustable shaft 4, and a console board 6. In one embodiment, the height of dental apparatus 1 may vary depending on the height of the user. Adjustable shaft 4 allows dental apparatus 1 to vary in height and adjust with the height of the user. In one exemplary embodiment, the height of dental apparatus 1 may extend up to three feet and eight inches. In one further embodiment, neck 5 is attached to shaft 4.

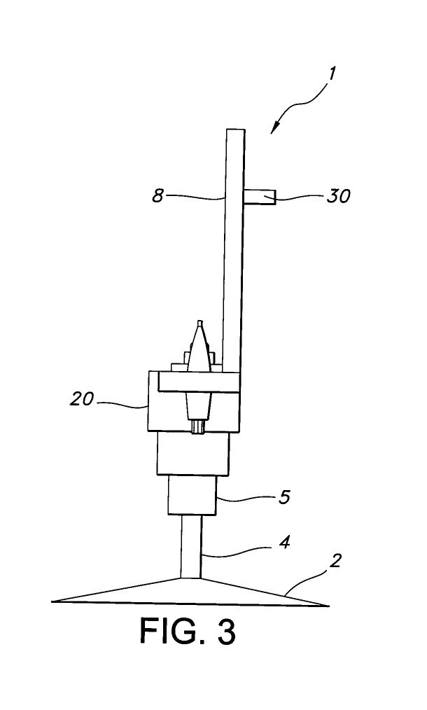

In a further embodiment, the apparatus 1 comprises a mirror 8 perpendicularly contiguous to console board 6. The mirror 8 may have a plurality of lights 10. In one embodiment, mirror 8 is collapsible allowing for easy storage and/or transport. Mirror 8 comprises handle 30 used to collapse mirror 8. Console board 6 further comprises a plurality of designated areas configured to support items used to practice proper dental hygiene. Such designated areas may include areas configured to support a tooth brush 12, mouth rinse 16, water cup/rinse cup 18, spitting cup and/or toothpaste 14. Console board 6 may comprise more or less designated areas as desired by one of skill in the art. In one embodiment, console board 6 comprises slot 26 (shown in FIGS. 2 and 3) for connecting a USB port or other device having a USB interface, such as a memory card reader, to apparatus 1.

In one embodiment, dental apparatus 1 comprises a system 20 that is configured to, among other functions, display the time, function as an alarm clock, function as a timer, play music and provide factual information. The alarm function may be set for one or more times of the day. When activated, the alarm summons or calls the user to the dental apparatus 1 to practice dental hygiene, including brushing teeth. For example, the alarm may be set to go off at seven o'clock am and seven o'clock pm. In a further embodiment, dental apparatus 1 has a first button 22 configured to turn off the alarm that summons a user to come to dental apparatus 1. In yet another embodiment, the dental apparatus 1 has a second button 24 which allows the user to reset the alarm. The timer function provided in the system 20 may be used to keep the user brushing for a predetermined amount of time during a single brushing session.

In one embodiment, system 20 may be equipped to provide factual information, by audio, visual or both, about dental anatomy and proper dental hygiene to the user while the user is using dental apparatus 1. In another embodiment, system 20 is equipped and may be programmed to play music as desired by the user while dental apparatus 1 is in use.

In yet another exemplary embodiment of dental apparatus 1, dental apparatus 1 comprises a brushing chart and a brushing club membership.

Referring to FIGS. 2 and 3, in one embodiment, console board 6 of dental apparatus 1 comprises compartment 28. Compartment 28 may be used for storage.

In various embodiments, dental apparatus 1 may be used to elicit a consistent and complete response by the user to practice proper dental hygiene. Dental apparatus 1 will simultaneously elicit a response from everyone hearing the dental apparatus alarm because it will increase the importance of proper dental hygiene, as all caregivers or family members of the user consistently hear factual information related to proper dental hygiene. Dental apparatus 1 allows users to take ownership of their own dental anatomy at an early age by encouraging and teaching proper dental hygiene. Dental apparatus 1 will reduce dental appointments for dental work which will in turn save time, money and comfort for a dental patient.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the disclosed invention and equivalents thereof.

1. An apparatus comprising:
a. a base support;
b. an adjustable shaft extending upward substantially perpendicular to the base support; and
c. a console board substantially parallel to the base support, wherein the console board comprises a plurality of designated areas.

2. The apparatus of claim 1, wherein the apparatus comprises a mirror contiguous to the console board, wherein the mirror extends upward perpendicular to the console board.

3. The apparatus of claim 2, wherein the mirror comprises a plurality of lights.

4. The apparatus of claim 2, wherein the mirror comprises a handle.

5. The apparatus of claim 1, wherein the console board comprises a slot.

6. The apparatus of claim 1, wherein the console board comprises a system.

7. The apparatus of claim 1, wherein the console board comprises a compartment.

8. The apparatus of claim 1, wherein a neck is contiguous to the shaft.

9. A method used to promote and practice proper dental hygiene, the method comprising the steps of:
a. obtaining an apparatus comprising a base support, an adjustable shaft extending upward substantially perpendicular to the base support, and a console board substantially parallel to the base support, wherein the console board comprises a plurality of designated areas and
b. using the apparatus to practice proper dental hygiene.

10. The method of claim 9, wherein the apparatus comprises a mirror contiguous to the console board, wherein the mirror extends upward perpendicular to the console board.

11. The method of claim 9, wherein the console board comprises a system.

12. The method of claim 11, wherein step (b) comprises setting an alarm to summon a user to the apparatus to practice dental hygiene.
